(19) United States
(12) Patent Application Publication
(10) Pub. No.: US 2007/0058091 A1
(43) Pub. Date: Mar. 15, 2007

(54) Flat display frame

(75) Inventor: Chin-Cheng Liao, Taichung City (TW)

Correspondence Address: BROWDY AND NEIMARK, P.L.L.C.;624 NINTH STREET, NW, SUITE 300, WASHINGTON, DC, 20001-5303, US

(73) Assignee: Eleo Corporation, Tanzih Township (TW)

(21) Appl. No.: 11/270,483

(22) Filed: Nov. 10, 2005

(30) Foreign Application Priority Data
Aug. 15, 2005 (TW) 94213929

(51) Int. Cl. H04N 5/645

(52) U.S. Cl. 348/825

(57) ABSTRACT

A flat display frame for a flat display of the present invention comprises four tube frames and a stander. Four tube frames which can construct a rectangle around the flat display; there is a 45 degrees bevel portion at each end of the tube frame. There is a contain portion that sets along the long axis of the tube frame locate on each of the tube frame and a decoration board can be mounted in the contain portion. The stander has a flat portion which can be placed on a surface and a support portion that mounted on the back of the flat display to provide a standing function.

### BACKGROUND OF THE INVENTION

1. Field of the Invention

The present invention relates generally to a flat display and more particularly to flat display frames.

2. Description of the Related Art

Most of the flat display frames selling in market now construct by a rectangle frame and a stander. Those rectangle frames constitute four tube frames that made by single material and single color. The unexciting design will cause the display products as a prosaic, monotone and normal product. Meanwhile, flat display always emphasize that slight and light of the weight is the most selling point, but the frames of the prior art that made of single material with single color show heavy and thickness image to people.

### SUMMARY OF THE INVENTION

The primary objective of the present invention is to provide flat display frames, which the flat display can show more colorful and changeable image.

According to the objective of the present invention, a flat display frame for a flat display, comprises: four tube frames which can construct a rectangle around the flat display; there is a 45 degrees bevel portion at each end of the tube frame; there is a contain portion that sets along the long axis of the tube frame locate on each of the tube frame and a decoration board can be mounted in the contain portion; the stander has a flat portion which can be placed on a surface and a support portion that mounted on the back of the flat display to provide a standing function.

### BRIEF DESCRIPTION OF THE DRAWINGS

FIG. 1 is a perspective view showing the tube frames and the decoration board of the present invention;

FIG. 2 is a perspective view showing the connection area of tube frames of the present invention;

FIG. 3 is a front view of the present invention;

FIG. 4 is a back view of the present invention;

FIG. 5 is a perspective view of the present invention, showing the flat board of the stander;

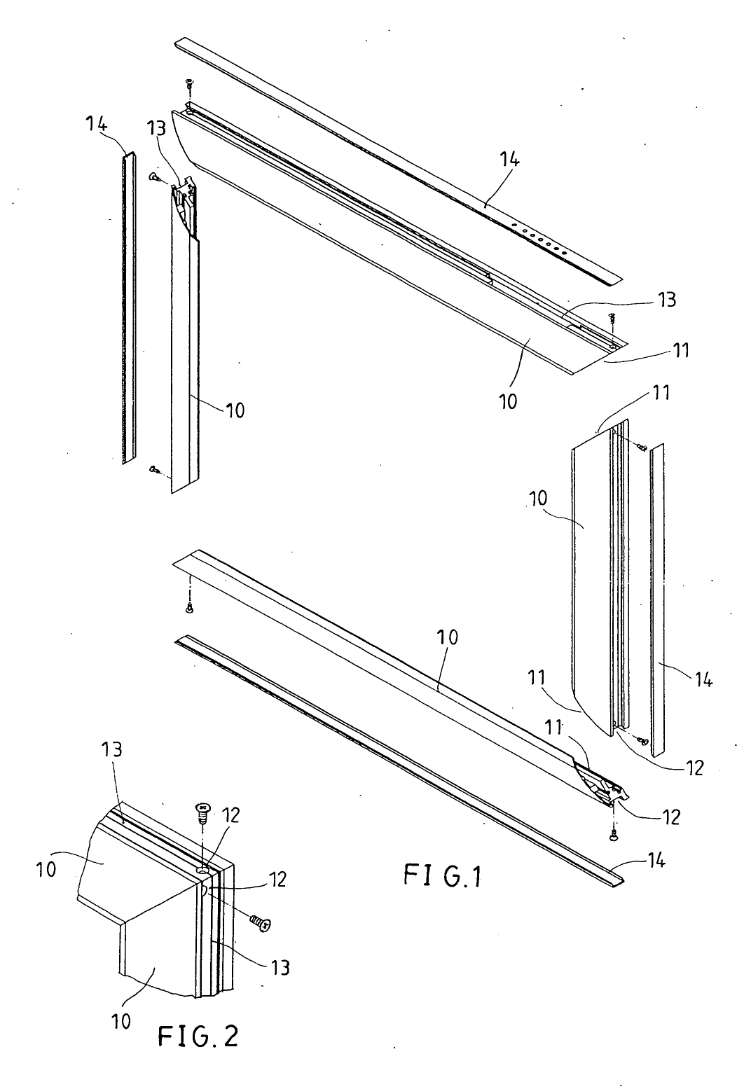

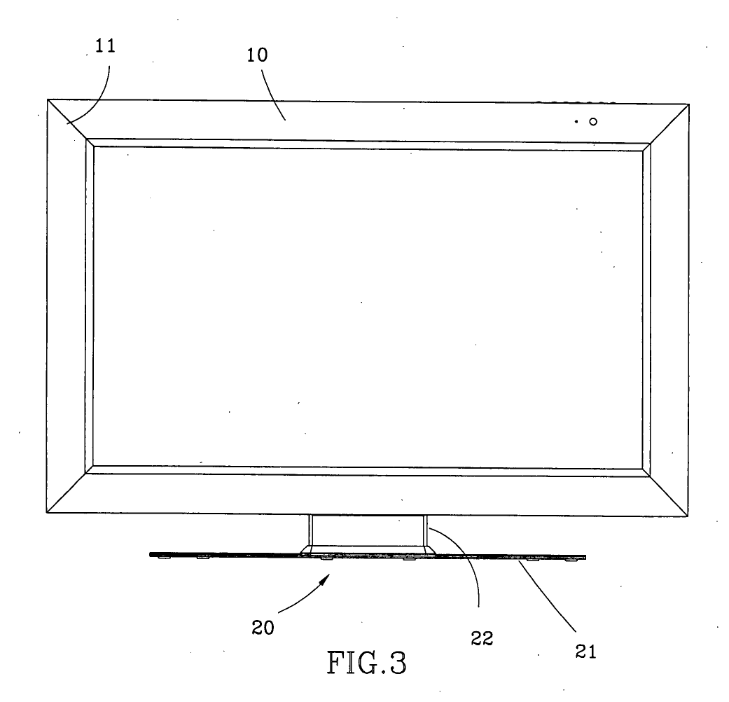

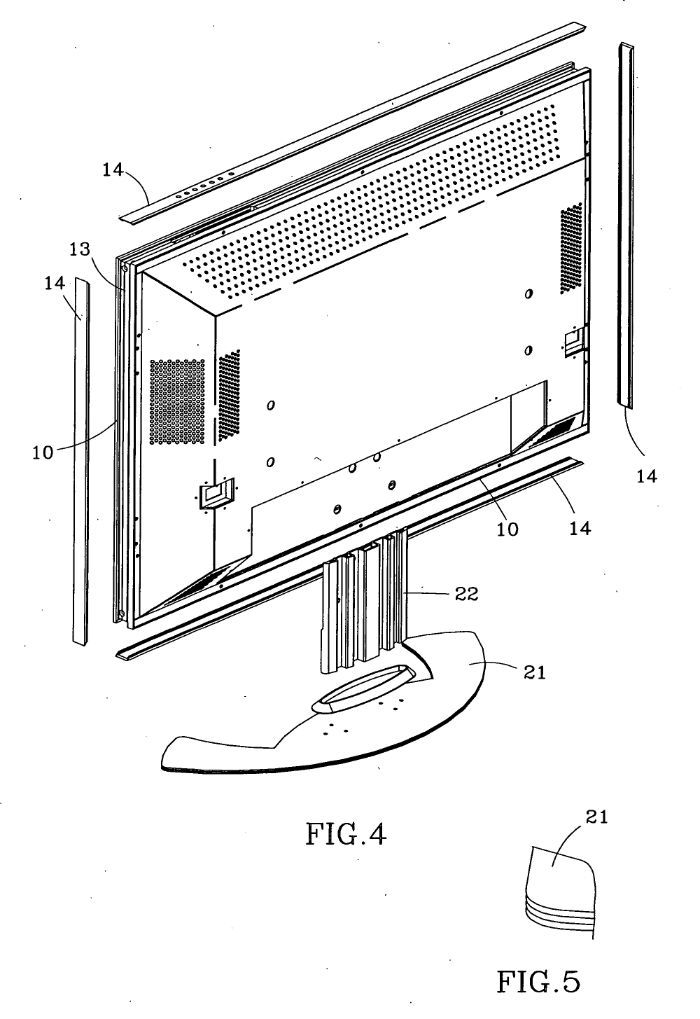

### DETAILED DESCRIPTION OF THE INVENTION

As shown in FIGS, a flat display frame for a flat display of the present invention comprises four tube frames and a stander.

Four tube frames 10 which can construct a rectangle around the flat display make by aluminum-extrusion. There is a 45 degrees bevel portion 11 with a connection portion 12 therein at each end of the tube frame 10. So, two tube frames can be connected by bolts and constructed a 90 degrees included angle. By the way, there are only 8 bolts are needed to construct the flat display frames. There is a contain portion 13 that sets along the long axis of the tube frame locate on each of the tube frame. A decoration board 14 can be mounted in the contain portion. In the embodiment of present invention, the contain portion is a trench that form by aluminum-extrusion and the decoration board with different color or material can be inserted into the trench. For example, the tube frame can be white and the decoration board can be red. The tube frames and the decoration boards can make by same or different material to showing the colorful and changeable image and different texture. For example, the decoration board can be made by metal, plastic, rubber or wood.

The stander 20 has a flat portion 21 which can be placed on a surface and a support portion 22 that mounted on the back of the flat display to provide a standing function. The flat portion 21 can be single structure with single color or several structures with color levels as the tube frame showing in FIG. 5.

Depend on the structures of present invention, the flat display frames show a 45 degrees oblique line at each corner in the front side. These oblique lines will make the flat display wider than fact in vision. Meanwhile, the levers that construct by the tube frame and the decoration board and show in the flank of the flat display make the whole product thinner than fact in vision. This advantage also can make the flat display of present invention more colorful and changeable than prior art.

What is claimed is:

1. A flat display frame for a flat display, comprising:
four tube frames which can construct a rectangle around the flat display; there is a 45 degrees bevel portion at each end of the tube frame so, two tube frames can be connected by bolts and constructed a 90 degrees included angle; there is a contain portion that sets along the long axis of the tube frame locate on each of the tube frame and a decoration board can be mounted in the contain portion;
the stander has a flat portion which can be placed on a surface and a support portion that mounted on the back of the flat display to provide a standing function.

2. The flat display frame as defined in claim 1, wherein the contain portion is a trench.

3. The flat display frame as defined in claim 2, wherein the decoration board can be inserted in to the trench.

4. The flat display frame as defined in claim 1, wherein each of the bevel portions has a connection portion therein.

5. The flat display frame as defined in claim 1, wherein the tube frame makes by aluminum-extrusion.

6. The flat display frame as defined in claim 1, wherein the decoration board makes by metal.

7. The flat display frame as defined in claim 1, wherein the decoration board makes by plastic.

8. The flat display frame as defined in claim 1, wherein the decoration board makes by rubber.

9. The flat display frame as defined in claim 1, wherein the decoration board makes by wood.

10. The flat display frame as defined in claim 1, wherein the flat portion can be several structures.
